(19) United States
(12) Patent Application Publication
(10) Pub. No.: US 2008/0204745 A1
(43) Pub. Date: Aug. 28, 2008

(54) Thin-Film Polarization Sample Cell For Biological And Chemical Agents And A Method Of Sampling

(75) Inventors: John Sloyer, Mashpee, MA (US); Thomas J. Novitsky, East Falmouth, MA (US)

Correspondence Address: Jonathan P. O'Brien;Miller Canfield Paddock and Stone, 444 W. Michigan Avenue, Kalamazoo, MI, 49007, US

(73) Assignee: CAPECOD BIOSYSTEMS INC, EAST FALMOUTH MASSACHUSETTS, MD (US)

(21) Appl. No.: 11/666,058

(22) PCT Filed: Oct. 21, 2005
(86) PCT No.: PCT/US05/38115

§ 371 Date: Jan. 8, 2008

Related U.S. Application Data
(60) Provisional application No. 60/620,736, filed on Oct. 21, 2004.

(51) Int. Cl. G01N 21/64; G01N 21/03

(52) U.S. Cl. 356/317; 356/246

(57) ABSTRACT

The present invention provides sample cells for use in thin film fluorescence polarization systems, methods of loading sample cells, and methods of detecting biological or chemical agents using thin film fluorescence polarization.

### CROSS-REFERENCE

This application claims priority to U.S. provisional patent application No. 60/620,737 filed on Oct. 21, 2004, hereby incorporated by reference.

### FIELD OF THE INVENTION

The present invention generally relates to systems for measuring fluorescence polarization. In particular, the invention relates to a thin film polarization sample cell that can be used in a fluorescence polarization spectrometry system utilizing a low volume/thin film optical sample and reagents for detecting biological and chemical agents in diverse environments (e.g. fluids and surfaces).

### BACKGROUND OF THE INVENTION

Biological and chemical agents occurring naturally or being accidentally or deliberately introduced into the environment are of special concern as they relate to their potential to cause disease or illness in humans and animals. Biological agents deliberately introduced into the environment in order to cause disease or illness, are of particular concern as agents of bioterrorism. Biological agents can be viable (living) or non-viable (dead) bacteria, fungi, viruses, protozoa, parasites up to and including arthropods, and components of the aforementioned, especially toxins either released from the living organisms while alive and actively growing, or released upon their death or dissemination in the environment. Biological agents, when used as bioterrorism agents, are usually produced in large quantities and mixed with a dispersing agent prior to release.

Chemical agents that cause disease or illness in humans and animals are also of special concern. Chemical agents can include a variety of toxins including drugs (e.g., narcotics, stimulants, or the like), carcinogens (e.g., asbestos, smoke, or the like), or the like that are generally considered man-made, i.e. not the product or byproduct of a biological process.

Biological and chemical agents can be introduced to animals and humans in a variety of vehicles. In several examples, biological and/or chemical agents can poison a water source, a food source, or can be dispersed in the atmosphere. Moreover, many chemical and biological agents are odorless in hazardous concentrations and microscopic, making their detection difficult.

In many cases, once biological or chemical agents are detected, protective measures can be taken to reduce the harm done by the agents. Thus, the present invention concerns detectors of biological and chemical agents.

Traditional detectors and detection methods suffer many limitations. Many detection methods employ lengthy assays, assays that require large sample volumes, or others only detect agents containing nucleic acids. Many detectors are too heavy to be used in the field, many detectors cannot operate in diverse environments (e.g. fluids and surfaces), while others are cost prohibitive, and still other detectors do not possess the sensitivity necessary to detect harmful levels of chemical or biological agents.

The inventors have recognized solutions to one or more of the problems above.

### SUMMARY OF THE INVENTION

In general, the invention relates to a thin film polarization sample cell for use in fluorescent polarization systems, methods of charging a sample cell, and methods of detecting biological and chemical agents.

In one aspect, a sample cell includes two optical plates, a spacer, and an input channel. The spacer is disposed between opposing surfaces of the optical plates to create a gap. An input channel communicates with the gap such that sample loaded on the input channel is drawn into the gap created by the two optical plates and the spacer. The sample cell can be used with a holder to align the sample cell in the optical path of a spectrometer.

In another aspect, a method of charging a sample cell with a sample includes providing a sample and charging the sample cell with the sample to form a thin film that can be analyzed using known fluorescent polarization spectroscopic methods. The sample can be formed into a thin film by loading it in the input channel, or by placing a small sample volume on one optical plate and sandwiching it along with the spacer between another optical plate; thus, creating a thin film.

Another aspect of the present invention provides a method of detecting biological or chemical agents using a thin film sample cell in known fluorescent polarization spectroscopy. In this aspect, the sample is introduced to a target-specific binding agent that binds to and forms fluorescing complexes with target molecules in the sample. The sample and binding agent are charged into the sample cell using methods discussed below to form a thin film in the sample cell. The sample cell is irradiated inside a spectrometer and the fluorescence of the sample is measured and evaluated using a calibration curve, which can be used to interpolate the presence and concentration of target molecules in the sample.

Embodiments of these aspects can include one or more of the following features.

The thickness of the gap is about 0.020 inches to about 0.006 inches. The volume of the gap between the opposing surfaces of the first and second optical plates is about 200 μL or less.

The input channel is formed by offsetting the opposing surfaces of the first and the second optical plates such that a portion of the opposing surface of the first optical plate, a portion of the opposing surface the second optical plate, or both, is not opposed by the other optical plate. The opposing surfaces of the first and second optical plates have different surface areas. The sample cell further includes a plurality of input channels each of which communicates with the gap. The opposing surfaces of the optical plates have a different shape. The shape of the opposing surface of the first optical plate is a polygon, such as a tetragon. The shape of the opposing surface of the second optical plate is a loop, such as a circle or oval. The first optical plate has a length from about 0.276 inches to about 1.00 inch and a width from about 0.276 inches to about 1.00 inch. The shape of the opposing surface of the first optical plate is a square. The second optical plate is a circle having a diameter equal to the length of one of the sides of the first optical plate. The input channel is formed as an aperture in the first optical plate, the second optical plate, or both. The sample cell further includes a gasket disposed about the perimeter of the first optical plate or the second optical plate. The input channel comprises a wick that can extend into the gap. The wick further comprises a binding agent.

The spacer comprises two support members disposed between the opposing surfaces of the optical plates and having a thickness of less than about 0.020 inches. The support members have a thickness between about 0.020 inches to about 0.006 inches.

The first optical plate, the second optical plate, or both, is at least partially optically clear. The first optical plate, the second optical plate, or both, comprises a substantially non-fluorescing material. The first optical plate, the second optical plate, or both is polarized. The first optical plate or the second optical plate is opaque. The first optical plate, the second optical plate, or both comprises a thermoplastic, a thermoset, a glass, or combinations thereof. The first optical plate, the second optical plate, or both comprise polystyrene. The first optical plate, the spacer, and the second optical plate are integrally formed. The spacer, the first optical plate, and the second optical plate form a unitary piece.

The sample cell further comprising a holder that engages the first optical plate, the second optical plate, or both, wherein the holder is configured to align the sample cell in an optical path of a spectrometer. The holder includes an opening to permit radiation to enter and exit the gap. The opening in the holder is an aperture having a diameter of between about 0.0250 inches to about 0.300 inches. The holder further includes one or more apertures each of which communicates with the input channel. The holder comprises a thermoplastic, such as polystyrene. The holder, the first optical plate, the second optical plate, and the spacer form a unitary piece. The holder, the first optical plate, the second optical plate, and the spacer form an integral piece. The holder is formed by blow molding.

The sample cell further comprises a binding agent disposed in the gap, such as immobilized in the gap or in the input channel.

The features and inventive aspects of the present invention will become more apparent upon reading the following detailed description, claims and drawings, of which the following is a brief description.

### BRIEF DESCRIPTION OF THE FIGURES

FIG. 1 is a schematic of a fluorescence polarization system (FPS) showing the components and their positions such as the sample holder;

FIG. 2 is an over-head view of one exemplary sample cell and holder according to the present invention;

FIG. 3 is a cross-sectional view, about segment A, of the sample cell and holder of FIG. 2;

FIG. 4 is another exemplary overhead view of a sample cell;

FIG. 5 is a three-dimensional view of an exemplary holder;

FIG. 6 is an overhead view of another sample cell of the present invention;

FIG. 7 is a cross-sectional view of the sample cell in FIG. 6 about segment B;

FIG. 8 is an overhead view of another sample cell of the present invention;

FIG. 9 is an overhead view of another sample cell of the present invention;

FIG. 10 is an overhead view of one exemplary configuration of a holder encasing a plurality of sample cells;

FIG. 11 is an overhead view of one exemplary configuration of a holder encasing a plurality of sample cells;

FIG. 12 is an exploded view of one exemplary sample cell that includes a wick; and

FIG. 13 details a typical TFP standard curve (cocaine example) from which the cocaine concentration in an actual sample can be calculated.

### DETAILED DESCRIPTION OF THE INVENTION

The present invention provides thin film polarization sample cells that can be used with fluorescence polarization systems that utilize thin-film fluorescence technology, or fluorescence polarization systems that follow traditional fluorescence spectroscopy technology; methods of charging a sample cell, and methods of detecting biological and/or chemical agents.

### Fluorescent Polarization Systems

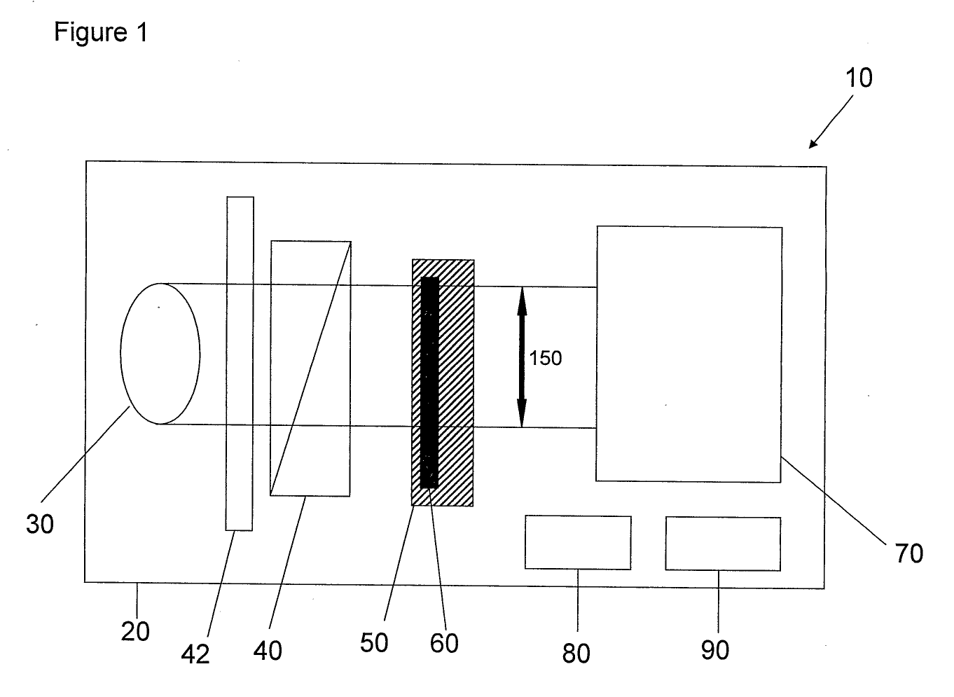

Referring to FIG. 1, a fluorescence polarization system (FPS) 10 includes a housing 20 for enclosing a light source 30, polarizing element 40, filter 42, holder 50 for retaining and positioning a sample cell 60 in an optical path 150, a detection system 70, central processing unit (CPU) 80, and power supply 90 (e.g., rechargeable batteries).

During operation, the light source 30 and polarizing element 40 filters the light to transmit light having a linear polarization. After traversing through sample cell 60, material in the sample cell emits fluorescence towards detection system 70, which records fluorescence and sends electronic signals to the CPU, which determines the normalized difference between the parallel and perpendicular polarization components of the emitted fluorescence.

The detection system may include a rotatable polarizing element that can be first orientated to transmit emitted fluorescence parallel to polarizing element 40 onto one detector and then rotated to transmit emitted fluorescence perpendicular to polarizing element 40 onto another detector.

Although the FPS 10 is described above with certain features, other embodiments may include different or additional components that permit the FPS to record the normalized difference between the parallel and perpendicular polarization components of the emitted fluorescence from the sample. For instance, the polarizing elements may be any optical element capable or transmitting or reflecting linearly polarized light. The detection system may include filters for blocking light from the light source from reaching the detectors. The light source may be any light source with filters to transmit light of specific energy, capable of exciting the sample to cause it to emit fluorescence.

### Sample Cells

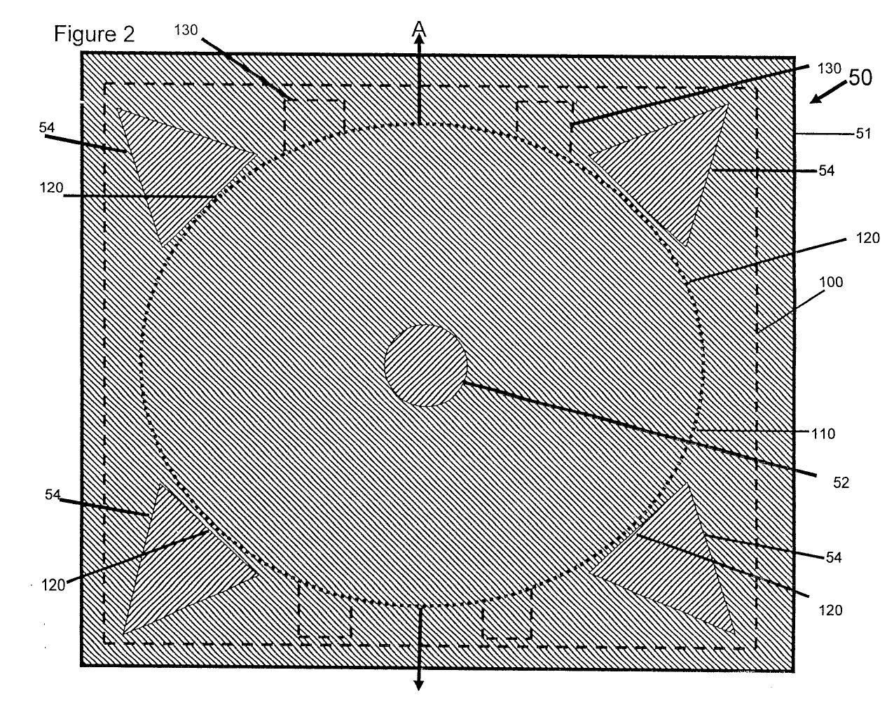

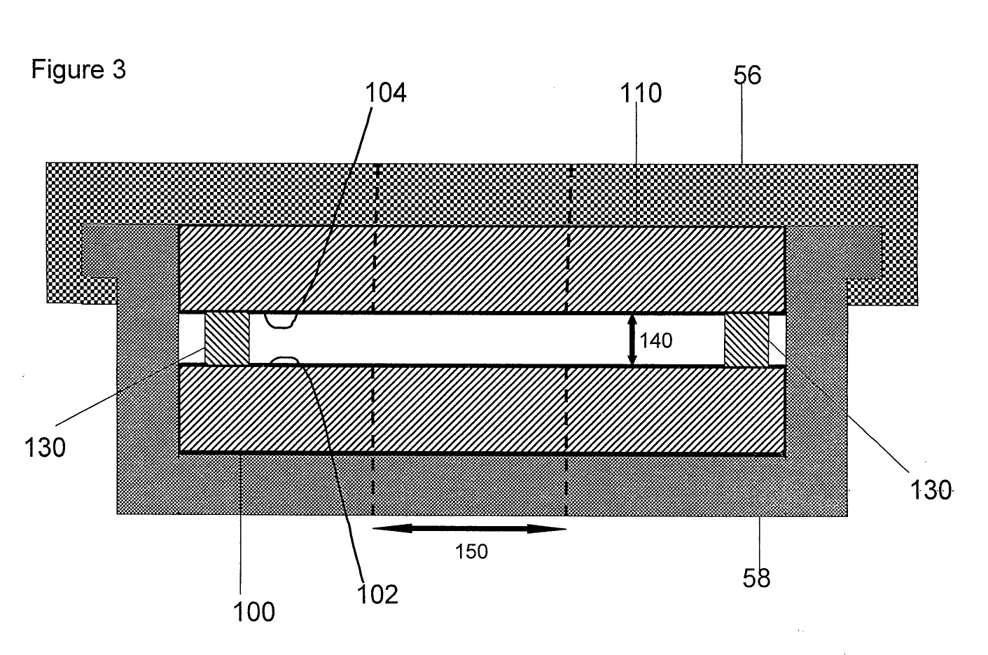

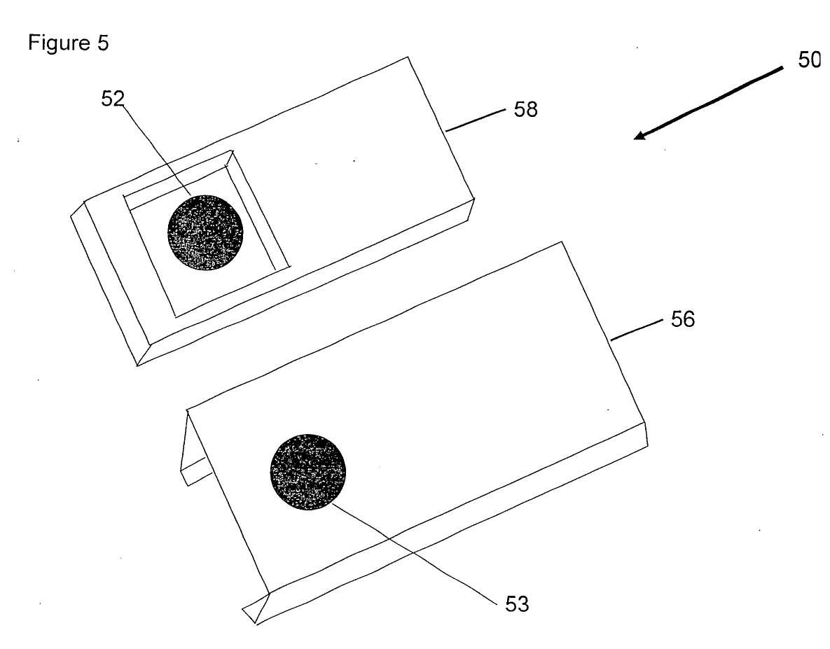

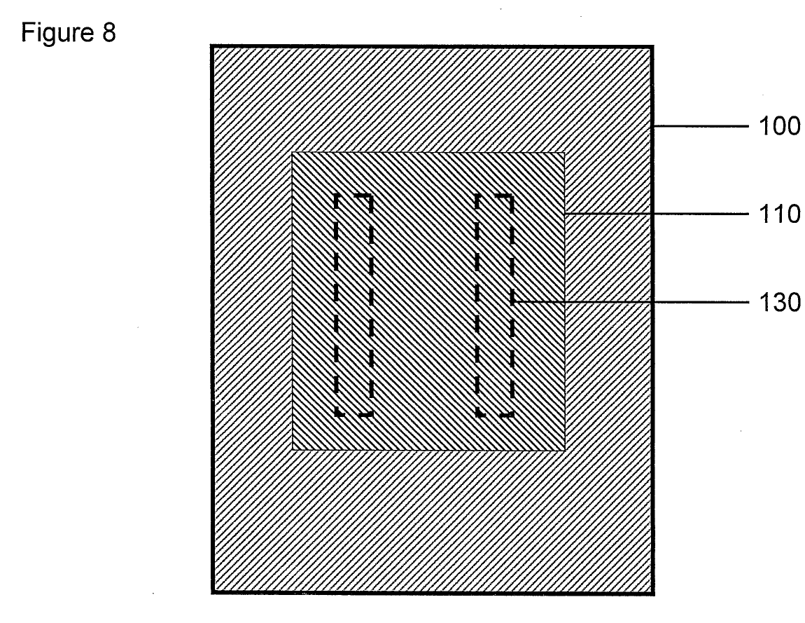

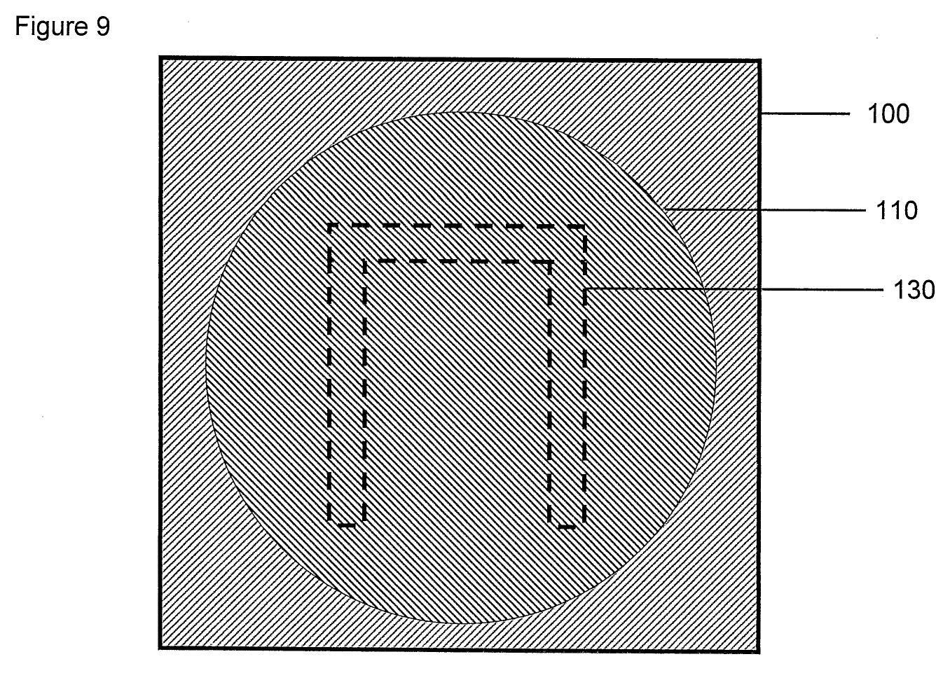

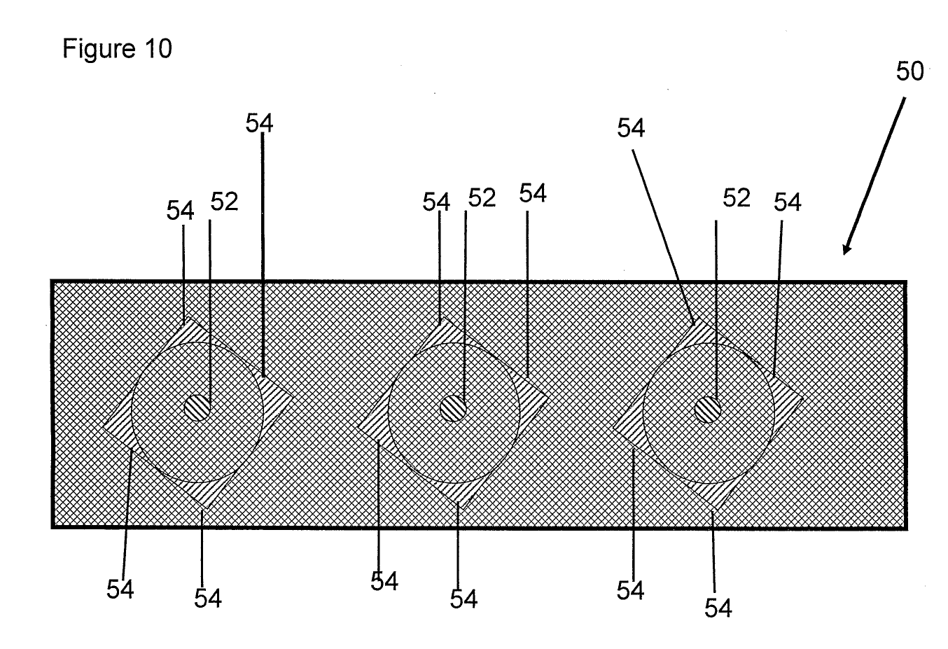

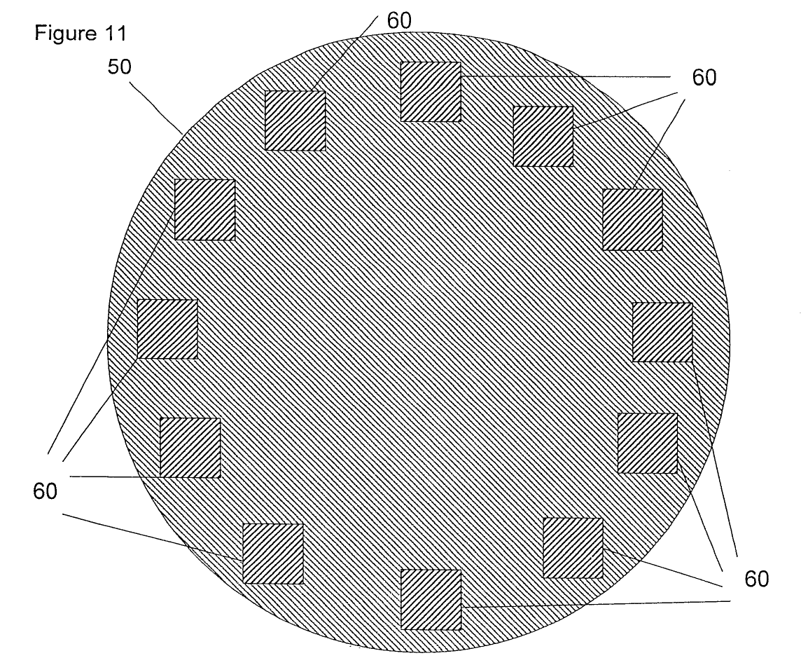

Referring to FIGS. 2-12, a sample cell includes a holder 50 having a housing 51 that encases the sample cell 60 and is configured to align the sample cell in an optical path 150 of a spectrometer (See FIG. 1). The holder 50 includes openings 52 and 53 that permit light to pass through the holder and irradiate the sample cell. The holder 50 also includes openings 54 that expose one or more input channels 120 on the sample cell. The holder comprises a front piece 56 that mechanically (e.g., with a hinge, screws, nuts and bolts, snap-fits, hook and loop, clips, tongue and groove, combinations thereof, or the like) engages a back piece 58 to encase the sample cell (See FIGS. 3 and 5). The holder comprises a thermoplastic; specifically, polystyrene. The sample cell 60 includes a first optical plate 100, a second optical plate 110, a plurality of input channels 120, and a spacer 130, wherein the spacer is disposed between the opposing surfaces 102, 104 of the first optical plate and the second optical plate to provide a gap 140. The opposing surfaces 102, 104 can be parallel or any angle less than 90 degrees such that the plates with the spacer therebetween form a gap which can hold and form a thin film sample by capillary action. In some embodiments, the optical plates are substantially parallel.

The input channels 120 communicate with the gap 140 such that when they are loaded with a sample, the sample forms a thin film in the gap 140. An input channel 120 is any structure, which can be part of one of the optical plates, that communicates with an input point to the gap of the sample cell. The input point is any point at which fluid is drawn between opposing surfaces of two optical plates via capillary action. In many embodiments, the input channel 120 is located peripheral to the input point, such as on exposed or unopposed areas of an optical plate surface that creates one side of the gap. In another embodiment, the input channel is located near the interface of the opposing surfaces, i.e., near the input point. The input channel can be an aperture, a grove, a platform, or the like formed in one or both of the optical plates or a wick, micro capillary tube, or the like which is attached to one or both of the optical plates or into the gap, so long as the input channel is capable of delivering a sample to the input point.

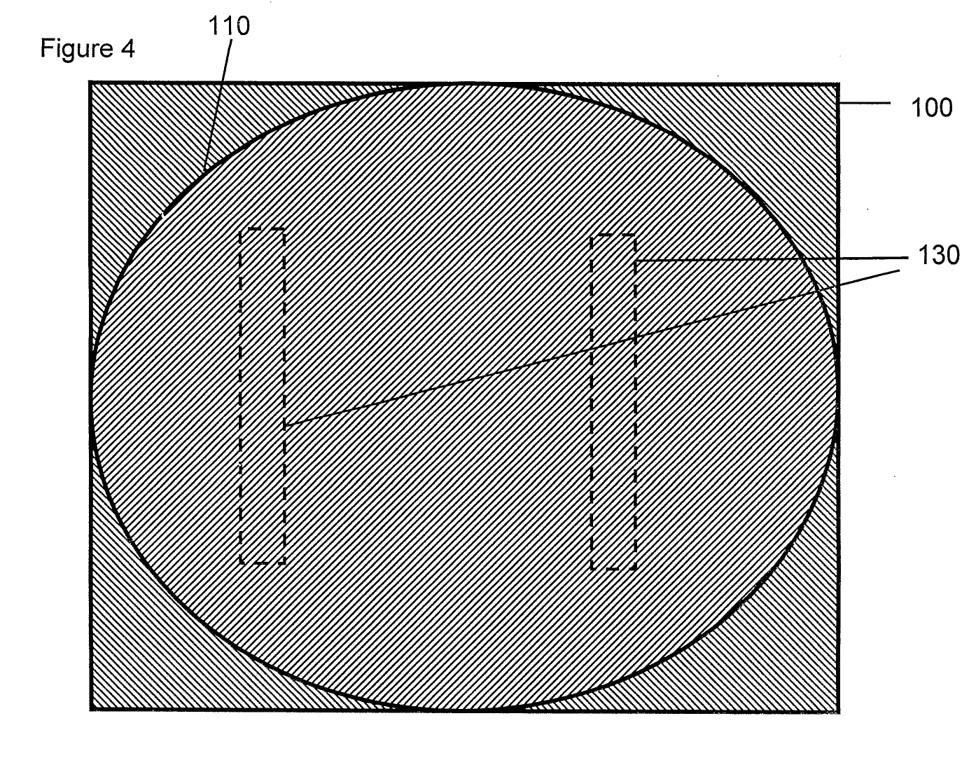

In one embodiment, shown in FIGS. 2 and 4, the optical plate(s), i.e., the first and second optical plates 100 and 110 respectively, are offset so that a portion of one of the surfaces that provides one side of the gap is not opposed by the surface of the other optical plate forming another side of the gap, i.e., the opposing surface of one optical plate includes and area that is exposed. The offset, e.g., exposed area, is created by the different shape of the optical plates; one plate having a square shape and another optical plate having a circular shape. The diameter of the circular optical plate approximately equals the length of the square optical plate, thus providing an offset at four areas (one at each corner of the square). The input channel 120 includes one or more (up to four) of these offset areas which allows sample to communicate with an input point which is located near the edge of the circular-shaped optical plate such as near any point where the surface of one optical plate opposes a surface of another optical plate. The spacer 130 includes two support members that are disposed between the opposing surfaces of the optical plates. The spacer further comprises a material that is inert and does not interfere with the sample.

Optical plates of the present invention (e.g., first and second optical plates) can comprise any shape and surface area such that a sample can be formed into a thin film between them. The shape and surface area for one optical plate can be selected independently from the shape and surface area for the other plate. One plate can have a surface in the shape of a polygon and another plate can have a surface in the shape of a loop. The optical plates can also comprise any material that has suitable optical clarity and can be used for fluorescence polarization spectroscopy. Furthermore, optical plates can be formed using any techniques known in the art such as injection molding, rolling, extruding, die-punching, blow molding, annealing, or the like.

In one embodiment, the optical plates comprise a substantially non-fluorescing material, i.e., material that does not substantially absorb high energy photons and re-emit lower energy photons. In another embodiment, the optical plates comprise a thermoplastic (e.g., polycarbonate, polystyrene, acrylonitrile-butadiene-styrene, styrene-acrylonitrile, polyvinylchloride, acetal, nylon, polyethylene, polypropylene, polyester, combinations thereof, or the like), a thermoset (e.g., phenolic resins, melamines, urea resins, combinations thereof, or the like), glass, or combinations thereof.

In another embodiment, the optical plates are at least partially optically clear, i.e., less than 100% of light is blocked from passing through the optical plate. In another embodiment, the optical plates are opaque such that light of only certain colors (e.g., red, orange, yellow, green, blue, indigo, violet, or combinations thereof) can pass through the material. In alternative embodiments, the optical plates are polarized. In another embodiment, optical plates are substantially optically clear, i.e., about 90% to about 99.99% of white light passes through them. In an alternative embodiment, the optical plates comprise polystyrene.

In one embodiment, one optical plate has a length from about 1.5 inches to about 0.20 inches and a width between about 1.5 inches and about 0.20 inches. In other embodiments, the first optical plate has a length from about 0.276 inches to about 1.00 inch and a width from about 0.276 inches to about 1.00 inch.

In another embodiment, not shown, the optical plates include optional guides on non-opposing surfaces that aid in aligning the optical plates in the holder, aligning the holder in the optical path of the spectrometer, or both. In another embodiment, optical plates include mechanical (e.g., clips, snap-fits, magnets, nuts and bolts, combinations thereof, or the like), or adhesive fasteners that fasten the sample cell to the holder or to the spectrometer. In another embodiment, one optical plate includes a gasket that is disposed around the perimeter of one or both of the plates.

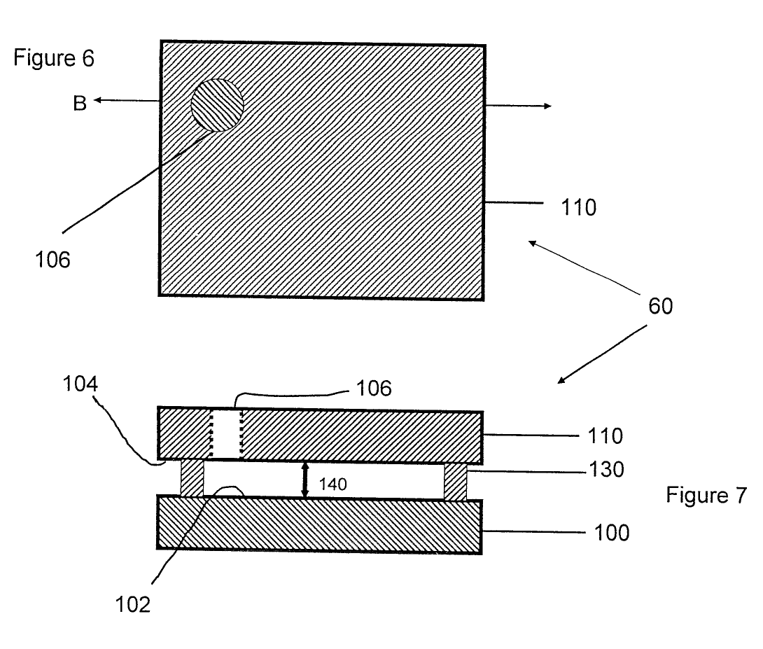

In another embodiment, depicted in FIG. 6, the first and second optical plates have approximately equal size and shape; however, one of the optical plates includes an aperture 106, such as a through hole, that is an input channel that is in fluidic communication with the gap formed by the optical plates and spacer. In this embodiment, one input point is located inside the aperture on the edge where the surfaces of the optical plates forming the gap interface, i.e., where the plates begin to oppose each other. Another input point can exist near another edge outside the aperture, such as the external edge of both optical plates, where the surfaces of the optical plates begin to oppose each other.

In another embodiment, not shown, both optical plates include apertures that form a through hole when the optical plates and the spacer are configured to provide the gap. This through hole is an input channel. Another input point can be located in the through hole near the interface of the opposing surfaces.

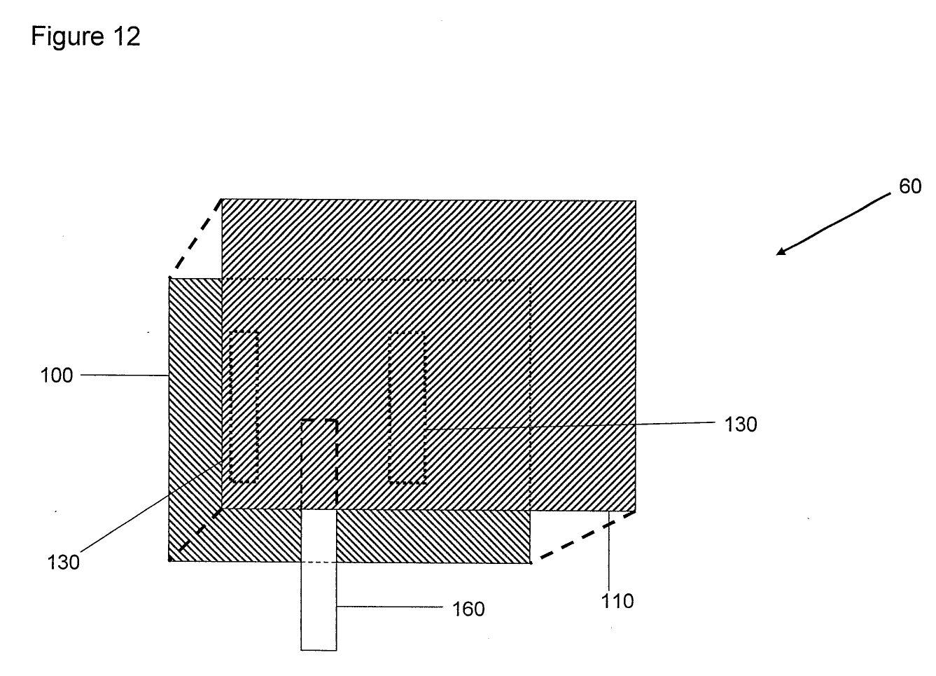

Referring to FIG. 12, the input channel can include a wick 160 that fluidly communicates with the gap. The wick is an absorbent material (e.g., sponge, woven or unwoven fibers, combinations thereof, or the like) or nonabsorbent material (e.g., micro capillary tube, or the like) that acts to transfer sample into the gap of the sample cells. In another embodiment, the spacer comprises a wick that that transfers sample into the gap of the sample cell. In still another embodiment, the wick extends into the gap.

In one embodiment, the spacer comprises one or more ridges formed on either of the optical plates. Several non-limiting examples of spacers are illustrated in FIGS. 4, 7, and 8. The spacer can be any thickness provided that it creates a gap that can draw in a fluidic sample by capillary action and hold the sample in the gap against the force of gravity. In certain embodiments, the spacer has a thickness of between about 0.006 inches and about 0.020 inches. The thickness of the spacer can also be selected so that the spacer is thick enough to compensate for any imperfections in flatness and uniformity of the opposing surfaces of the optical plates which can increase the error of the fluorescence polarization measurements. For instance, the spacer can be selected to be as thick as the thickness of one of the optical plates. In certain embodiments, the optical plates can have a thickness ranging from about 0.007 inches to about 0.005 inches and the spacer has a thickness of between about 0.020 inches and about 0.006 inches. Sample cells utilizing spacers that are selected to compensate for any imperfections in flatness and uniformity of the opposing surfaces of the optical plates decrease the standard deviation of fluorescence polarization measurements (e.g., decrease the standard deviation below 2 mP).

In another embodiment, the spacer has a thickness of less than about 0.020 inches (e.g., about 0.020 inches to about 0.006 inches), and together with the opposing surfaces of the optical plates, provides a gap with a width of less than about 0.020 inches. In another embodiment, the gap formed by the spacer and the opposing surfaces of the optical plates can hold a fluid volume of 200 μL or less.

In another embodiment, the optical plates and the spacer form a unitary piece. The optical plates can be attached to each other and the spacer with mechanical (e.g., screws, snap fits, nut and bolt, clips, magnets, combinations thereof, or the like) or adhesive (e.g., optically clear epoxy) fasteners. As a unitary piece, the spacer can be attached to either of the optical plates, or both plates; one optical plate can be attached to the spacer, the other optical plate, or both; or combinations thereof.

In another embodiment, the optical plates and the spacer form an integral piece. As an integral piece, the spacer and the optical plates include the same material or are formed as a single piece without mechanical or adhesive fasteners. In several examples of integral pieces, the optical plates are cast in the same mold as the spacer, or the spacer and the plates are formed of the same molding compound (e.g. polystyrene) during a single molding process (e.g., blow molding). In another example, the spacer is welded to both optical plates.

In another embodiment, the holder engages the sample cell with a depression that corresponds to the size and shape of the sample cell. In another embodiment, the holder engages the sample cell with mechanical or adhesive fasteners. In an alternative embodiment, the holder and the sample cell form a unitary piece or an integral piece. In another embodiment, the holder encases a plurality of sample cells. The holder along with the plurality of sample cells can form a unitary piece or an integral piece.

The holder can be formed of any known material including metals (e.g., iron, copper, aluminum, tin, brass, bronze, steel, lead, titanium, combinations thereof, or the like), thermoplastics, thermosets, glass, elastomers (e.g., natural or synthetic rubber, or the like), or other known materials.

### Methods of Loading a Sample Cell

Another aspect of the present invention provides methods of loading a sample cell including providing a sample and charging a sample cell described above.

As used herein, the term aqueous solution means any sample containing water in any concentration which may include soluble and insoluble components including by not limited to salts, sugars, bacteria, bacterial components, viruses, viral components, fungi, fungal components, plants, plant materials and/or extracts, drugs, chemicals, proteins, and nucleic acids. The aqueous solution may be completely biologic in origin such as urine, saliva and other bodily secretions or components either neat or diluted with water, or saline or other aqueous solutions (e.g., buffers). The concentrations of aqueous sample will be chosen as to maximize signal and minimize background in order to increase the sensitivity and specificity of the particular assay.

In one method, an appropriate volume of sample is collected using any proper techniques known in the art. The sample is loaded into an input channel and drawn, via capillary action, into the gap, where it forms a thin film. Samples include aqueous solutions such as biological fluids (e.g., blood, sweat, saliva, urine, interstitial fluid, bile, spinal fluid, or the like), ground and/or tap water, fuel (gasoline, diesel, or the like), beverages (e.g., soda, fruit juice, tea, coffee, or the like), combinations thereof, or other fluids without limitation). Moreover, samples can include washes from surface swipes.

In another embodiment, the sample is loaded into the input channel or an opposing surface of an optical plate with a pipette; however, any suitable method of delivering an appropriate volume of sample (e.g., about 200 μL to about 1 μL) can be used. Without limitation, suitable methods include using a pipette, a syringe, eyedropper, or other vessel that can deliver a suitable volume of sample to the input channel or the opposing surface of an optical plate.

In another embodiment, the sample is introduced to a target-specific binding agent that binds to the target molecules in the sample to form a fluorescing complex. The sample can be introduced to the binding agent before it is charged into the sample cell, or after it is charged into the sample cell.

In several embodiments, the sample cell does not include an input channel. In these embodiments, the sample and binding agent can be added to one side of one optical plate and the other optical plate can be placed on top to “sandwich” the sample. This sandwich containing the sample and binding agents is then placed in placed in the TFP system for reading. Alternatively, the sample and/or binding agents are added to two optical plates, which are placed back-to-back by placing a small drop of sample and/or agent fluid to the edge of the plates. Capillary action wicks the fluid into the gap between the optical plates. The filled plates are optionally placed in the holder and into the TFP machine for reading. In still other embodiments, the sample cell may be pre-loaded with binding agent. For instance, the agent can be pre-loaded into the sample cell such as by freeze drying or by adding reagent to the sample cell during manufacturing or before bringing the TFP system out into the field for testing. Alternately, nonabsorbent spacers can be used to precisely control the volume of the sample to optimize the optical volume. In this case it is still the liquid of the sample that separates the walls of the thin film, i.e., it is the surface tension of the liquid that holds the walls together and not the spacers. The liquid can still be introduced as above, either by capillary action through one or more input channels (e.g., gaps on the spacer, or absorbent wick(s)). The liquid, once in place, is gravity independent, i.e. capillarity prevents downward pooling and in turn allows the instrument to be used in any orientation and in zero gravity, i.e. outer space. Absorbent and non absorbent spacers could be combined as well as various shapes to promote sample mixing, reagent separation, or combinations thereof. Note that the gasket or spacer does not serve as a seal.

When the input channel includes the optional wick, the wick can be dipped or otherwise contacted with the sample to load the input channel with sample. Without intending to be limited by theory, it is theorized that the sample forms a thin film in the gap by capillary action.

### Methods of Detecting Biological or Chemical Agents

In another aspect, the invention features a method of performing fluorescence polarization to detect the presence of a chemical or biologic agent. The method includes the step of providing a portable fluorescence polarization system having a sample cell for holding a thin-film of sample in the optical path of the fluorescence polarization system. The method further includes recording fluorescence polarization measurements, such as from a direct fluorescence assay or an indirect fluorescence assay. The method can also employ reflected light or epifluorescence spectroscopy, in this case, only one side of the sample cell needs to be optically clear. Epifluorescence spectroscopy would lend itself to opaque samples as well as allow a wick to extend into and fill the entire gap formed by the optical plates and the spacer.

Sample cells of the present invention can optionally comprise one or more binding agents. Suitable binding agents can be antibodies, nanobodies, antibody fragments, binding agents, or other biological or chemical entities that have a high and specific affinity for the target agents. They can be fluorescent labeled (direct assay) or unlabeled (indirect assay). In the former, labeled antibody is directly added to the sample and the difference in signal is related to the quantity of target molecule present or absent in the sample. In the later, unlabeled antibody is added to the sample in the presence and absence of labeled target molecule. The difference between the two assays is indicative of the amount of unlabeled target molecules contained in the sample, i.e. the labeled and unlabeled molecules “compete” for binding with the antibody of binding molecule. The binding agent may be immobilized in a dry state in the sample cell or on the input channel and reconstituted with solvent from the sample. Alternatively, the binding agent can be added to the sample before or after loading the sample in the cell. In several sample cells, the binding agent(s) can be disposed in the gap, the wick, the input channel, or combinations thereof. Table 1 contains a summary of the signal strength of in situ reconstituted dry tracer standard compared with added liquid tracer standard using TFP.

TABLE 1

| Tracer | Dried (mP) | Reconstituted (mP) |
|---|---|---|
| Standard | 153.8 | 19.8 |
| Antibody | 314.7 | 210.1 |

### EXAMPLES

### Example 1

### Indirect Assay for Cocaine

Using the a fluorescent polarization spectrometer FPS, microliter volumes of cocaine tracer and antibody indicator reveal a FPS signal compatible with an antibody system. The presence of cocaine in a sample would interfere with the signal and therefore, the percent of interference/competition is related to the concentration of cocaine. The higher the percent of interference, the higher the concentration of cocaine. In this example, 500 picograms of cocaine was used. The results are summarized in Table 2 below.

The test for cocaine is performed as follows:
1) 1 μL of capture antibody is mixed with 500 picograms of cocaine on a optical plate;
2) within seconds 7 μL of tracer is added and a second optical plate placed over the mixture;
3) the thin film is read in the FP device and mP displayed in 10 seconds;
4) simultaneously the mP is converted to % inhibition from a stored standard curve and the cocaine concentration is displayed.

### Example 2

### Indirect Assay for Marijuana Using a Modification of Abbott's TDX reagents for Marijuana

Using the FPS system, microliter volumes of marijuana tracer and antibody indicator reveal a FPS signal compatible with an antibody system. The presence of marijuana in a sample would interfere with the signal and therefore, the percent of interference/competition is related to the concentration of marijuana. The higher the percent of interference, the higher the concentration of marijuana. In this example, 245 picograms of marijuana was used. The results are summarized in Table 2 below.

Test is performed as follows:
1) 7 μL of capture antibody is mixed with 245 picograms of marijuana on a optical plate;
2) within seconds 7 μL of tracer is added and a second optical plate placed over the mixture;
3) the thin film is read in the FPS and mP displayed in 10 seconds;
4) simultaneously the mP is converted to % inhibition from a stored standard curve and the marijuana concentration is displayed.

TABLE 2
Indirect Assay of Marijuana and
Cocaine Using Thin-Film Samples

| SAMPLE | mP | Standard Deviation (n = 10) |
|---|---|---|
| 7 μl Cocaine Tracer | 158.8 | +/−2.7 |
| Tracer + Indicator(Antibody) | 213.2 | +/−1.8 |
| Tracer + Indicator(Antibody) + | 166.9 | +/−1.7 (85% Competitive) |
| Cocaine Sample | | |
| 7 μl Marijuana Tracer | 133.6 | +/−4.3 |
| Tracer + Indicator(Antibody) | 200.5 | +/−6.6 |
| Tracer + Indicator(Antibody) + | 155.2 | +/−2.5 (68% Competitive) |
| Marijuana Sample | | |

### Example 3

### Standard Curve for Cocaine

During operation, the amount of chemical or biological agent present in a sample can be determined by measuring the resulting normalized polarization difference (miliRho, e.g., mP) and comparing that value to a calibration curve that can be stored in the systems CPU. The calibration curve may be obtained by measuring mP for a series of samples having known concentrations of chemical or biological agents.

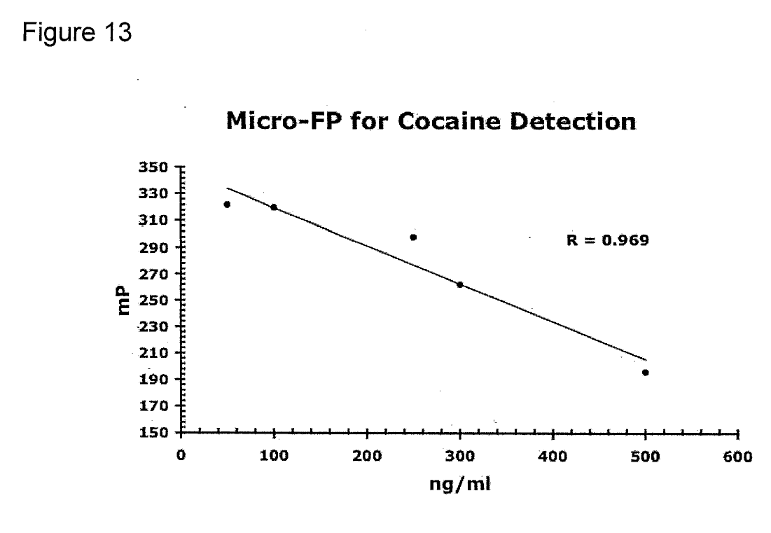

FIG. 13 is a plot of a calibration curve generated for cocaine. The theoretical sensitivity limit is 60 ng/ml at a 5% competitive inhibition. The calibration curve is generated as follows:
1) 1 μL of capture antibody is mixed with various picogram concentrations (50 to 500 pg) of cocaine on optical plates (each concentration on a different optical plate);
2) within seconds 7 μL of tracer is added and a second optical plate placed over the mixture;
3) the thin film is read in the FPS and mP displayed in 10 seconds;
4) the mP is plotted against cocaine concentration (ng/ml);
5) the % mP reduction is calculated for each cocaine concentration from that of the sample with no cocaine;
6) the % mP reduction (inhibition) is plotted against cocaine concentration.

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. A sample cell for use in a thin-film fluorescence polarization system comprising:
a first optical plate;
a second optical plate;
a spacer; and
an input channel,
wherein the spacer is disposed between the first optical plate and the second optical plate to provide a gap between opposing surfaces of the first and second optical plates; the first optical plate and the second optical plate are configured to provide the input channel that communicates with the gap such that when the input channel is loaded with a sample, the sample forms a thin-film having a thickness of less than about 0.200 inches in the gap.

2. The sample cell of claim 1, wherein the thickness of the gap is about 0.06 inches to about 0.115 inches.

3. The sample cell of claim 1, wherein the volume of the gap between the opposing surfaces of the first and second optical plates is about 200 μl or less.

4. The sample cell of claim 1, wherein the input channel is formed by offsetting the opposing surfaces of the first and the second optical plates such that a portion of the opposing surface of the first optical plate, a portion of the opposing surface the second optical plate, or both, is not opposed by the other optical plate.

5. The sample cell of claim 4, wherein the opposing surfaces of the first and second optical plates have different surface areas.

6. The sample cell of claim 5, further comprising a plurality of input channels each of which communicates with the gap.

7. The sample cell of claim 4, wherein the opposing surfaces of the optical plates have a different shape.

8. The sample cell of claim 7, wherein the shape of the opposing surface of the first optical plate is a polygon.

9. The sample cell of claim 7, wherein the shape of the opposing surface of the second optical plate is a loop.

10. The sample cell of claim 8, wherein shape of the opposing surface of the first optical plate is a tetragon.

11. The sample cell of claim 10, wherein the first optical plate has a length from about 0.276 inches to about 1.00 inch and a width from about 0.276 inches to about 1.00 inch.

12. The sample cell of claim 10, wherein the shape of the opposing surface of the first optical plate is a square.

13. The sample cell of claim 12, wherein the shape the opposing surface of the second optical plate is a circle.

14. The sample cell of claim 13, wherein the diameter of the circle is equal to the length of one of the sides of the first optical plate.

15. The sample cell of claim 4, wherein the input channel is formed as an aperture in the first optical plate, the second optical plate, or both.

16. The sample cell of claim 1, further comprising a gasket disposed about the perimeter of the first optical plate or the second optical plate.

17. The sample cell of claim 1, wherein the spacer comprises two support members disposed between the opposing surfaces of the optical plates and having a thickness of less than about 0.020 inches.

18. The sample cell of claim 17, wherein the support members have a thickness between about 0.06 inches to about 0.115 inches.

19. The sample cell of claim 1, wherein the input channel comprises a wick.

20. The sample cell of claim 19, wherein the wick extends into the gap.

21. The sample cell claim 20, wherein the wick further comprises a binding agent.

22. The sample cell of claim 1, wherein the first optical plate, the second optical plate, or both, is at least partially optically clear.

23. The sample cell of claim 1, wherein the first optical plate, the second optical plate, or both, comprises a substantially non-fluorescing material.

24. The sample cell of claim 1, wherein the first optical plate, the second optical plate, or both is polarized.

25. The sample cell of claim 1, wherein the first optical plate or the second optical plate is opaque.

26. The sample cell of claim 1, wherein the first optical plate, the second optical plate, or both comprises a thermoplastic, a thermoset, a glass, or combinations thereof.

27. The sample cell of claim 1, wherein the first optical plate, the second optical plate, or both comprise polystyrene.

28. The sample cell of claim 1, wherein the first optical plate, the spacer, and the second optical plate are integrally formed.

29. The sample cell of claim 1, wherein the spacer, the first optical plate, and the second optical plate form a unitary piece.

30. The sample cell of claim 2, further comprising a holder that engages the first optical plate, the second optical plate, or both, wherein the holder is configured to align the sample cell in an optical path of a spectrometer.

31. The sample cell of claim 30, wherein the holder includes an opening to permit radiation to enter and exit the gap.

32. The sample cell of claim 31, wherein the opening is an aperture having a diameter of between about 0.0250 inches to about 0.300 inches.

33. The sample cell of claim 30, wherein the holder includes an aperture which communicates with the input channel.

34. The sample cell of claim 33, wherein the holder includes a plurality of apertures each of which communicates with an input channel.

35. The sample cell of claim 30, wherein the holder comprises a thermoplastic.

36. The sample cell of claim 35, wherein the holder comprises polystyrene.

37. The sample cell of claim 36, wherein the holder, the first optical plate, the second optical plate, and the spacer form a unitary piece.

38. The sample cell of claim 37, wherein the holder, the first optical plate, the second optical plate, and the spacer form an integral piece.

39. The sample cell of claim 2, wherein the holder is formed by blow molding.

40. The sample cell of claim 1, further comprising a binding agent disposed in the gap.

41. A sample cell for use in a thin-film fluorescence polarization system, comprising:
a holder for engaging a plurality of cells; and
a plurality of cells engaged in the holder, wherein each cell includes a first optical plate, a second optical plate, a spacer, and an input channel in which the spacer is disposed between the first optical plate and the second optical plate to provide a gap between opposing surfaces of the first and second optical plates; the first optical plate and the second optical plate are configured to provide the input channel that communicates with the gap such that when the input channel is loaded with a sample, the sample forms a thin-film having a thickness of less than about 0.200 inches in the gap; and wherein the holder is configured to align the cells in an optical path of spectrometer.

42. The sample cell of claim 41, wherein the thickness of the gap in each cell is between about 0.06 inches to about 0.115 inches.

43. The sample cell of claim 41, wherein the volume of the gap between the opposing surfaces of the first and second optical plates in each cell is about 200 μl or less.

44. A method of charging a sample cell for use in a thin film fluorescence polarization system comprising:
providing a sample;
charging a sample cell;
wherein the sample cell has a first optical plate, a second optical plate, a spacer, and an input channel; the spacer is disposed between the first optical plate and the second optical plate to provide a gap between opposing surfaces of the first and second optical plates; the first optical plate and the second optical plate are configured to provide the input channel that communicates with the gap such that when the input channel is loaded with a sample, the sample forms a thin-film having a thickness of less than about 0.200 inches in the gap.

45. The sample cell of claim 44, wherein the thickness of the gap is about 0.06 inches to about 0.115 inches.

46. The method of claim 44, wherein the gap has a volume of less than about 200 μL.

47. The method of claim 44, wherein the sample cell further comprises a binding agent.

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. The method of claim 47, further comprises introducing the sample to the binding agent.

86. (canceled)

87. The method of claim 85, wherein the sample is introduced to a first binding agent to form a complex, and the complex is introduced to a second binding agent.

88. The method of claim 85, wherein the binding agent comprises an antibody, a nanobody, or both.

89. A method of detecting a biological or chemical agent using thin film fluorescence polarization spectroscopy comprising:
providing a sample;
introducing the sample to a binding agent;
charging a sample cell with the sample;
irradiating the charged sample cell;
measuring the fluorescence of the sample cell; and
recording the spectroscopy,
wherein the sample cell comprises a first optical plate, a second optical plate, a spacer, and an input channel; the spacer is disposed between the first optical plate and the second optical plate to provide a gap; the first optical plate and the second optical plate are configured to provide the input channel; the input channel communicates with the gap such that when the input channel is loaded with a sample, the sample forms a thin film having a thickness of less than about 0.200; and
wherein the binding reagent is capable of fluorescing when it is bound to the sample.

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106-109. (canceled)
